(19) United States
(12) Patent Application Publication
(10) Pub. No.: US 2016/0224901 A1
(43) Pub. Date: Aug. 4, 2016

(54) MULTIPLE DEVICE CORRELATION

(71) Applicant: VODAFONE IP LICENSING LIMITED, Newbury, Berkshire (GB)

(72) Inventor: Kevin Scarr, London (GB)

(21) Appl. No.: 14/977,346

(22) PCT Filed: Jun. 20, 2014
(86) PCT No.: PCT/GB2014/051902

§ 371 Date: Dec. 21, 2015

(30) Foreign Application Priority Data
Jun. 20, 2013 (GB) 1311037.4
Sep. 9, 2013 (GB) 1316022.1

(51) Int. Cl. G06N 7/00; H04L 29/08

(52) U.S. Cl. CPC G06N 7/005; H04L 67/22

(57) ABSTRACT

Methods for detecting a common user of a plurality of user devices in a network and for detecting a common cohort for a plurality of users are disclosed. The methods comprise receiving a plurality of event records. Each of the event records corresponds to an event in a network and comprises a device identifier and event information. A correlation is then calculated between a first subset of the event records having a first device identifier and a second subset of the event records having a second device identifier. Based on the correlation, it is then calculated whether the first and second device identifiers relate to user devices associated with the same user, and whether the first and second device identifiers relate to user devices associated with users belonging to a common cohort.

### BACKGROUND

Every business or service operates within a spatial dimension—whether this is a physical location such as a retail outlet or a virtual location via a website. In order to effectively operate the business or service, it is essential to understand the demographics and psychographic behaviour of the customers and the users of the business or service. This process is known as “footfall analytics”.

Typically, footfall analytics are performed within the retail business sector and are concerned with measuring the number of visitors to a retail outlet and the demographics of those visitors, and ideally how these translate to sales.

Footfall analytics is not just limited to the retail environment however. For example, a hospital may wish to understand the movements of its patients, a local authority may wish to understand the impact of a planned event or an online retailer may wish to understand where their customers are when using the service.

One area where footfall analytics has a particularly important application is in the field of facility management. Modern facilities comprise a number of subsystems which are configured to control aspects of the facilities. This can include both indoor facilities (such as buildings) and outdoor facilities (such as streets).

Some subsystems are controlled based on the number or characteristics of the people that are present in a given location. This traditionally involves manually counting the number of people who enter a location and interviewing a sample to determine their characteristics, such as their reason for visiting the location. This manually gathered information can then be used to approximate the number and characteristics of people in the area in the future. Based on this approximation, the various parameters of the subsystem (such as output levels and set-points) can be set. However, a key weakness with this manual process is that it is a very time-consuming to initially gather the data. Further, because the data is not at all real-time, and in fact relies on a past sample being extrapolated for future occasions, it can be very inaccurate, causing poor performance of the subsystems.

Although accurate footfall analytics would provide the best basis for automated control of subsystems, the difficulty with gathering the data has led to attempts in the prior art to consider other approaches. Some subsystems can be automatically controlled by linking the subsystem to one or more sensors. The output of the subsystem could then be automatically adjusted based on the sensor reading. For example, an air conditioning subsystem may be configured to regulate the temperature within an area to remain within two set-points, based on periodic or continuous sensor readings. However, such an approach is only suitable where there is an easily measured output, and in any case requires monitoring infrastructure to be installed and maintained.

A particularly coarse method of automatic control involves using motion sensors or the like to determine the presence of one or more people. However, this does not provide any indication of the number or kind of people who are present, and is prone to a large number of false positives and true negatives. Such methods therefore are only appropriate in very limited situations where accuracy and precision is not so important. For example, it is very difficult (or even practically impossible) to determine whether a person is a repeat visitor. While it may be possible for such sensors to determine whether a person is an adult or a child (based on the size of the person), even this is typically very inaccurate and unreliable. Any further analysis is generally impossible.

Thus there is a need in the art for improvements in methods of analysing user footfall and of controlling associated subsystems based on user footfall, or to at least provide the public with a useful choice.

### SUMMARY OF INVENTION

According to a first aspect, there is provided a method for detecting a common user of a plurality of user devices in a network. First, a plurality of event records is received. Each of the event records corresponds to an event in a network (such as a telecommunications network) and comprises a device identifier and event information. A correlation can then be calculated between a first subset of the plurality of event records having a first device identifier and a second subset of the plurality of event records having a second device identifier different from the first device identifier. Based on the correlation, it is then calculated whether the first and second device identifiers relate to user devices associated with the same user. In this manner, two otherwise unrelated user devices can be calculated as being related to the same user. This can then allow for a more accurate user count, by avoiding the double-counting that would otherwise occur.

Calculating a correlation may comprise generating a first matrix based on the event dates, the event times and the event locations of each of the event records in the first subset; generating a second matrix mapping event dates, event times and event locations of each of the event records in the second subset; comparing the first matrix and the second matrix; and based on the comparison, calculating a probability that the first and second device identifiers relate to user devices associated with the same user. This provides an efficient method for correlating the usage patterns of the two devices, while reflecting that any inference is unlikely to be perfectly certain.

Calculating whether the device identifiers relate to user devices associated with the same user may comprise, if the probability is above a threshold value, recording that the device identifiers relate to user devices associated with the same user. The threshold value may be selected depending on the level of accuracy that is required in the ultimate use. For example, in security-related applications where a high level of accuracy is required, the threshold may be set to 0.8 or higher.

Calculating the probability may comprise calculating the number of entries in the first matrix which match entries in the second matrix as a proportion of the total number of entries in the first matrix. The weights may be based on the time of day. This provides a computationally efficient method for calculating the probability.

In preferred embodiments, the method further comprises calculating one or more weights for one or more locations or for one or more ordered sets of locations; and calculating the probability based on the weights. Thus where certain locations or ordered sets of locations are deemed to be particularly conclusive (such as those involving the home location of a user), these may be given more sway over the probability than locations that are common to a large number of users (such as a work location).

According to a second aspect there is provided a method for detecting a common cohort for a plurality of users of user devices in a network. First, a plurality of event records is received, each event record corresponding to an event in a network (such as a telecommunications network) and comprising a device identifier and event information. A correlation can then be calculated between a first subset of the plurality of event records having a first device identifier and a second subset of the plurality of event records having a second device identifier different from the first device identifier. Based on the correlation, it is then calculated whether the first and second device identifiers relate to user devices associated with users belonging to a common cohort. In this manner, relationships between users can be determined.

Calculating a correlation may comprise generating a first matrix based on the event dates, the event times and the event locations of each of the event records in the first subset; generating a second matrix mapping event dates, event times and event locations of each of the event records in the second subset; comparing the first matrix and the second matrix; and based on the comparison, calculating a probability that the first and second device identifiers relate to user devices associated with users belonging to a common cohort. This provides an efficient method for correlating the usage patterns of the two devices, while reflecting that any inference is unlikely to be perfectly certain.

Comparing the first matrix and the second matrix may comprise selecting a mask based on a type of cohort; applying the mask to the first matrix to generate a first masked matrix; applying the mask to the second matrix to generate a second masked matrix; and comparing the first masked matrix and the second masked matrix. This allows the cohort inference to based only on a selection of the time slots in each matrix. This reflects that certain time slots are more likely to be correlated with certain cohorts (such as day time slots are likely to relate to co-workers), thereby improving the accuracy of the inference.

Generating a matrix in the first or second aspect may comprise dividing a time period into a plurality of time slots; determining a location for each time slot; and recording the location in the matrix.

In doing so, determining a location may comprise one or more of:

retrieving the start time of the time slot; selecting an event record in the subset of event records having time data closest to the start time; recording the location of the event record as the location for the time slot; or

retrieving the start time of the time slot; selecting an event record in the subset of event records having time data closest to the start time; temporarily recording the location of the event record as the location for the time slot; aggregating the plurality of time slots into a plurality of time slot groups; calculating the most common location across each time slot group; and recording the most common location for each time slot group as the location for each of the time slots in time slot group; or

dividing each time slot into a plurality of sub-slots, the plurality of sub-slots comprising two edge sub-slots and one or more central sub-slots; for each edge sub-slot: retrieving the start time of the edge sub-slot; selecting an event record in the subset of event records having time data closest to the start time; and recording the location of the event record as the locations for the edge sub-slot; for each central sub-slot: retrieving the start time of the time slot; selecting an event record in the subset of event records having time data closest to the start time; and temporarily recording the location of the event record as the location for the time slot; calculating the most common location across the central sub-slots; and recording the most common location for each central sub-slot; or

identifying one or more second users associated with first user; retrieving a matrix for each second user; and recording the location for a time slot in the matrix of one or more of the second users as the location for a corresponding time slot in the matrix associated with the first user.

In preferred embodiments, prior to calculating a correlation, the method may further comprise: calculating a most common location for the first device; calculating a most common location for the second device; comparing the most common location for the first device with the most common location for the second device; and based on the comparison, determining whether the first and second devices could be associated with the same user. This provides a fast pre-filter to eliminate pairs of user devices where it is practically impossible that they relate to the same user. This reduces the overall computational complexity of the method.

In a third aspect, there is provided a computer-readable medium having computer-executable instructions stored thereon which, when executed by a computer, cause the computer to perform the method of the first or second aspects.

### BRIEF DESCRIPTION

The present invention will now be described with reference to the accompanying drawings, in which:

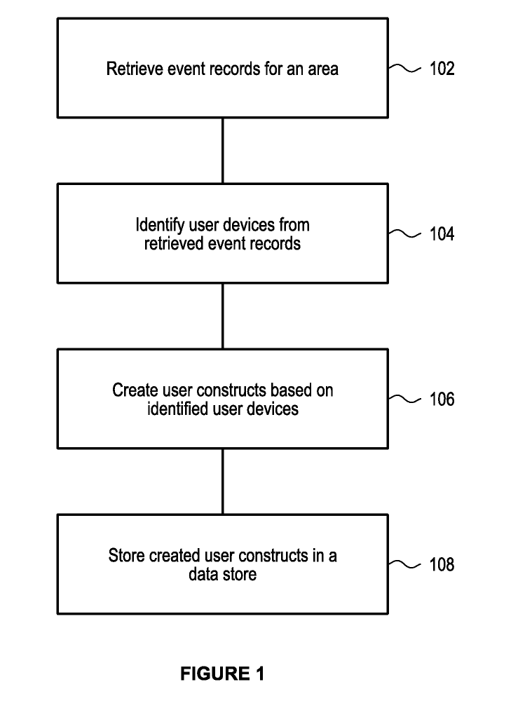

FIG. 1 shows a method for processing the event records for use in footfall analytics;

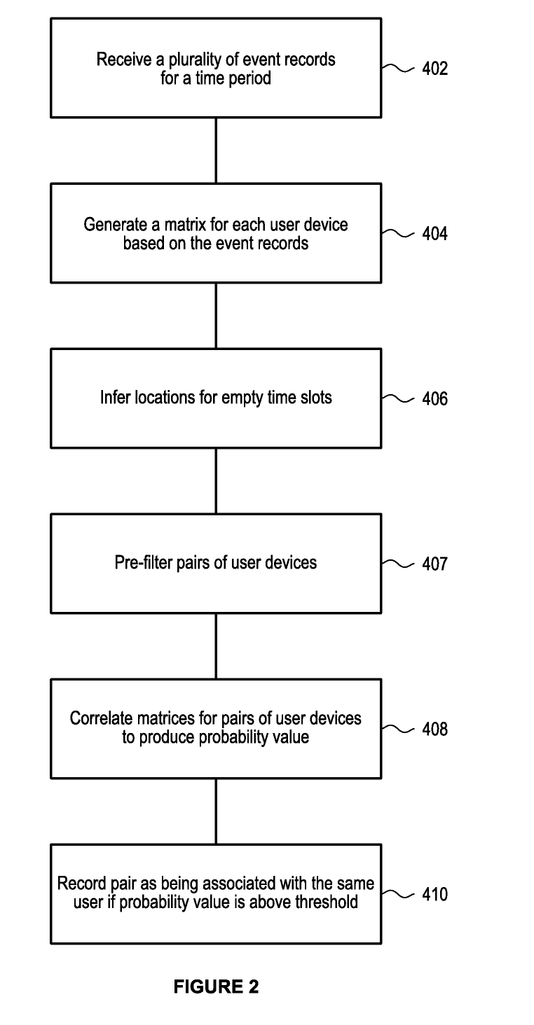

FIG. 2 shows a method for inferring a common user associated with a plurality of user devices;

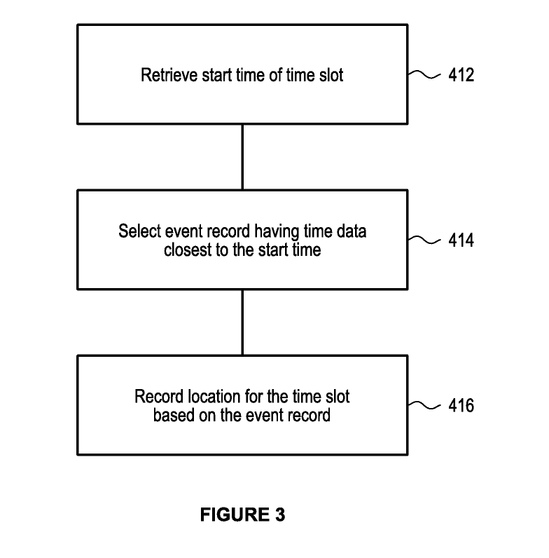

FIG. 3 shows a first exemplary method for mapping locations to time slots in a matrix;

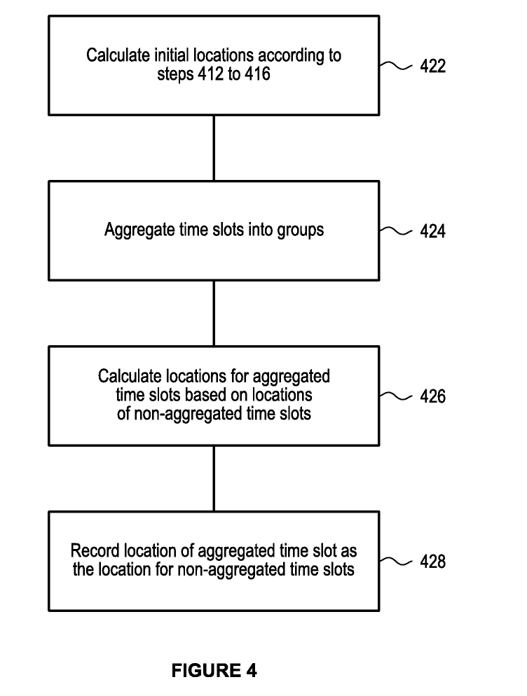

FIG. 4 shows a second exemplary method for mapping locations to time slots in a matrix;

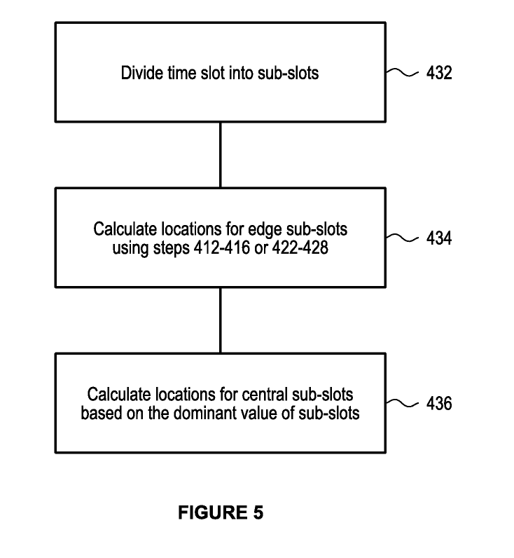

FIG. 5 shows a third exemplary method for mapping locations to time slots in a matrix;

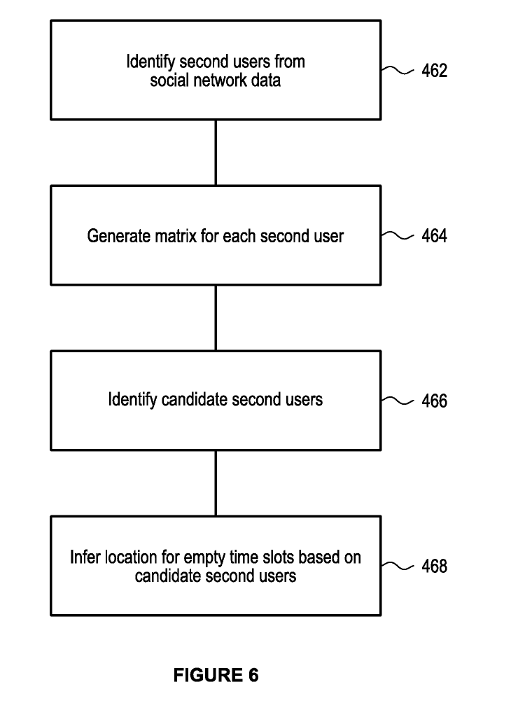

FIG. 6 shows an exemplary method for inferring a location for an empty time slot in a matrix;

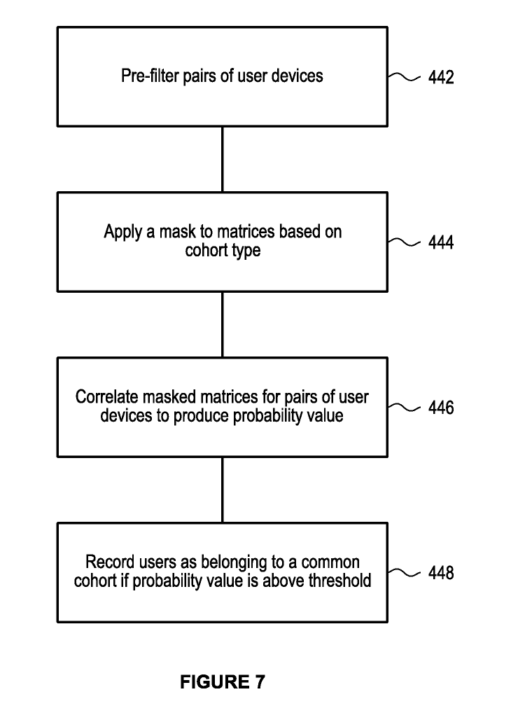

FIG. 7 shows a method for inferring that users belong to a common cohort;

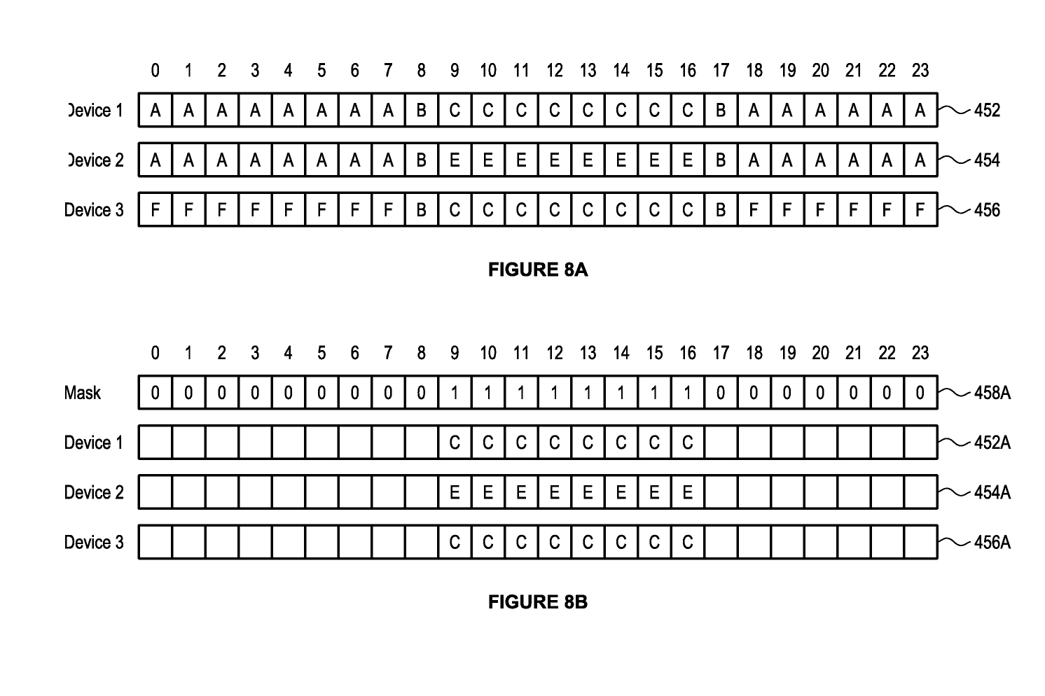

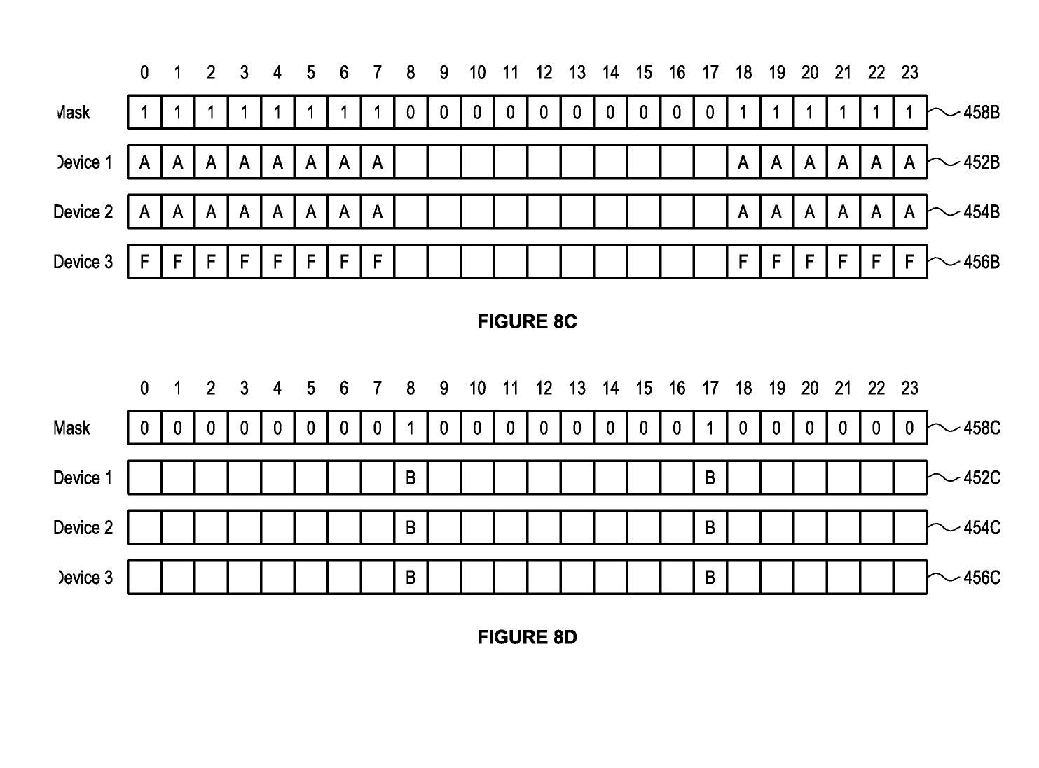

FIGS. 8A to 8D show examples of applying a mask to matrices for the purposes of inferring that users belong to a common cohort;

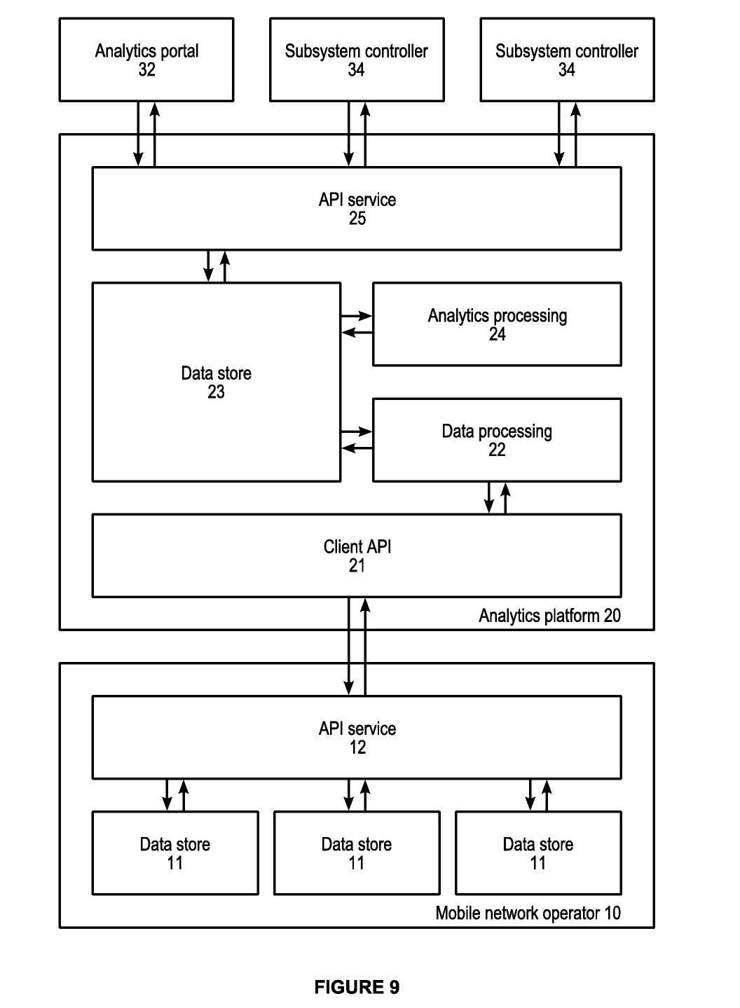

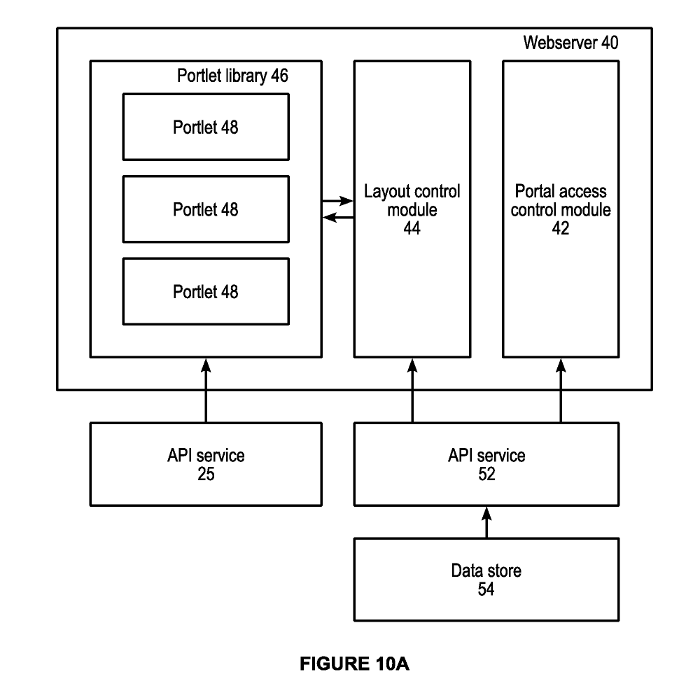

FIG. 9 shows an exemplary system for implementing the described methods; and

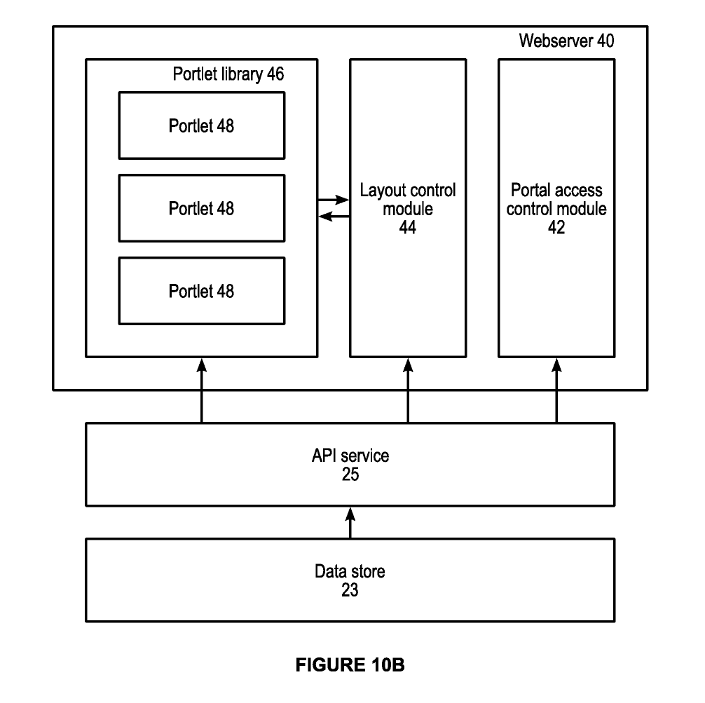

FIGS. 10A and 10B show exemplary embodiments for an analytics portal.

### DETAILED DESCRIPTION

In order to achieve any useful footfall analytics, the relevant data must first be gathered. In practice, the vast majority of people carry one or more devices with them which communicate with a base station (or telecommunications node) for mobile services and the like. Typically, a device communicates with the nearest base station.

Based on this, if a device is connected to a base station, it can be reasoned that the device is located within the area around the base station which is closer to the base station than to any other base station. This analysis can be modelled mathematically using a Voronoi algorithm to divide a large aeoaraohical area with a plurality of base stations into cells. Of course, other methodologies can be used to map mobile telecommunication cells and/or communication coverage areas into geographical areas. Each cell can therefore be mapped to a geographical area which will typically be centred on the base station.

The base station can be a conventional mobile telephony base station, providing services to a macrocell which covers an area several kilometres across. In some settings, smaller cells (such as femtocells) may also be used, particularly where service is required indoors. In such cases, each floor or room of a building may be a separate cell, and user devices can communicate with the base station for their floor.

In use, the user device communicates with the base station. In doing so, the base station typically generates and stores event records based on the events that have occurred. These events can, for example, include a phone call being established or a text message being sent. Each event record comprises time data indicating when the event occurred, device data indicating the user device that was involved, type data indicating the type of event that occurred, and cell data indicating the network cell in which the event occurred.

The time data can include a date and a time at which the event started, and the duration of the event. Alternatively, it can include a first date and time at which the event started, and a second date time at which the event finished.

The device data uniquely identifies the device which was involved in the event. This is typically by means of one or more IDs which map to a device, a user account or a user. Commonly, this includes one or more of an MSISDN for the device, an IMSI for a user (or a SIM card or device associated with the user), or an IMEI for the device. In some cases, anonymised IDs (particularly an anonymised MSISDN) may be used.

The type data identifies the type of event that occurred. For example, the event type data may indicate that the event was a telephone call. This may be done by means of a code which corresponds to an entry in a look-up table.

The cell data can be simply an identifier for the cell. However, using the mapping between cells and geographical areas, the cell data can also be used as a geographical identifier. Accordingly, using this mapping, location data for the event record can be easily computed which identifies a geographical area or location at which the event occurred.

In many cases, the event records are generated during the ordinary operation of the base station. In this case, there is little additional overhead to generate the event records, as the event records will be generated regardless of whether they are to be used for footfall analytics. In some cases, the event records may include charging data records (CDRs) generated for charging a user's account.

Although the event records above have been described with reference to events occurring at a base station, event records may additionally or alternatively be generated and/or retrieved from outside of the operation of a base station. In particular, event records may comprise records of events occurring in other networks. For example, the event records may relate to a non-telecommunication network (such as requests and responses passing through a WiFi network), the use of GPS, the internal state of devices (such as a device being switched on or connecting to a different cell) or the like.

### Data Gathering

Turning now to FIG. 1, a method for processing the event records for a geographical area is shown. Facility management subsystems are typically configured to provide services to different areas separately. For example, lighting may be required in a first area, but not a second area, even though both areas are managed by a single subsystem. It can therefore be useful to consider event records for each geographical area separately.

At step 102, event records are retrieved for a given geographical area. To do so, the identifier for the one or more cells corresponding to the geographical area is retrieved. This can be done using a look-up table or the like, which maps locations to cells. The stored event records are then filtered to produce a subset of event records relating to the identified cell. Thus, the subset only relates to events that occur within the given geographical area.

At step 104, a set of devices is identified, each of which has at least one corresponding event record in the subset of event records. The event records can then be split into multiple further subsets, each of which relate to a single user device.

At step 106, a user construct is generated for the subset relating to each user device. Each user construct comprises the subset of the event records which relate to a device, and which in turn relate to a nominal user. In some cases, a user construct can actually relate to multiple devices, for example if a single user carries two devices with them.

The user constructs can be created without necessarily having any knowledge of the users directly. In this manner, the user constructs may be anonymous. Moreover, because each user construct may only relate to a single area, the same actual user may be seen as a first user construct in a first area, and a separate second user construct in a second area.

At step 108, these user constructs are stored in a data store for future use. Once the user constructs are generated and stored, footfall analysis can be performed.

### Inferring a User of Multiple Devices

As noted above, in many cases each user device can be presumed to correspond to a user. Thus, for example, the number of users in a location can be calculated as being equal to the number of user devices at the location.

However in reality, some users carry multiple devices with them. For example, a user may carry a mobile phone for work purposes and another mobile phone for personal purposes. Depending on the prevalence of this, it may cause some of the footfall analytics to be incorrect. In general, this error manifests by overstating the number of people at a given location. Thus while the count based on devices may give an indication of a number of people (which may be sufficient for some purposes), it is unlikely to be accurate.

FIG. 2 shows a method for determining which can be used to identify multiple user devices associated with a single user.

At step 402, a plurality of event records are received for a given time period. The time period is typically chosen so as to be reasonably representative of a normal user's schedule. For example, this may be 1 week, such that the event records would be expected to cover the general lifestyle.

The plurality of event records is split into subsets. Each of the subsets contains only event records relating to a single device. This is done using the device data in each event record (which may be an MSISDN or similar). The subset preferably contains event records for every event relating to each device over the time period. This ensures that a comparison between two devices is maximally accurate.

At step 404, a matrix is generated for each user device based on the event records in the subset of event records relating to that user device. The matrix maps the location of the user device to time slots during the time period. The length of the time slots is chosen to be regular enough that the movements of the user device are generally accurately modelled. A time period of between about 1 minute and about 15 minutes has been found to be suitable.

The mapping in the matrix can occur according to one of three methods.

A first method for mapping is shown in FIG. 3. Here, at step 412, the start time of the time slot is retrieved. At step 414, the event record in the subset of event records having time data closest to the start time is selected. At step 416, the location for that event record is calculated and recorded as the location for that time slot.

A second method for mapping is shown in FIG. 4. Here, at step 422, the locations for each of the time slots is calculated initially based on the first method, as shown in FIG. 3. At step 424, the time slots are then aggregated into groups. For example, five non-aggregated 1-minute time slots may form a single aggregated 5-minute time slot.

At step 426, the location for the aggregated time slot is calculated based on the locations of the non-aggregated time slots. If there is a dominant location across the non-aggregated time slots (that is, there is one location more common than any other), then the dominant location is selected to be the location for the aggregated time slot. Where there is no dominant location, a random location may be selected or the location of a neighbouring aggregated time slot used.

Finally at step 428, the location of the aggregated time slot is recorded as the location for each of the non-aggregated time slots.

A third method for mapping is shown in FIG. 5. At step 432, the time slot is divided into three or more sequential sub-slots, each corresponding to a portion of the period of the time slot. The matrix is adjusted to accommodate the sub-slots.

At step 434, the locations for the edge sub-slots (that is, those at the start and the end of the time slot) are calculated and recorded as if they were undivided time slots using the first method or the second method above. In other words, a change at the start or end of a period can be noted separately from the dominant value in that time slot. This allows transitions between locations to be recorded, even where the transition is not a dominant value.

At step 436, the locations for the one or more central sub-slots (that is, the sub-slots which are not edge sub-slots) are calculated and recorded as being the dominant value of the whole time slot or of the central sub-slots.

Each of the methods may be beneficial in different circumstances. For example, in some implementations there is a need to minimise power consumption, such as on the edge of a network. In such cases, a less computationally intensive method (such as the first method) may be preferred.

Where power consumption or computational requirements are less of a concern, the second or third methods may be preferred, as these may provide higher accuracy results. Typically, the second method may be preferred where there are no transitions at the start or the end of a time slot, and the third method may be preferred when there are such transitions.

Independent of which method is used, the matrix mapping each time slot to a location is produced. However, in some cases there may be empty time slots in the matrix. This can occur if the device was involved in no events during that time, or may reflect a gap in the underlying data. In cases such as these, the method of FIG. 2 may then proceed to step 406, where the locations for empty time slots are inferred.

In general cases, where both the preceding and subsequent time slots relate to the same location, the location for the empty intermediate time slot could be reasoned to be the same. Where the locations of the preceding and subsequent time slots are not the same, the location of the empty time slot may be inferred by looking at the same time on other days for the user. In this manner, a pattern can be derived and used to fill the empty time slots.

An alternative approach to inferring the locations for empty time slots may be taken when external social network data is available. Such data can indicate that two users are socially connected somehow. This connection may be based on social network systems where users explicitly connect themselves to other users (through “friending” or the like), but may additionally or alternatively include incidental communications between the users (phone calls, text messages, emails or the like), money transfers, entries in address books or anything similar.

An exemplary embodiment of inferring a location based on social network data is shown in FIG. 6.

At step 462, one or more second users are identified based on the social network data. Typically each second user has a first-degree relationship to the first user (that is they are directly connected to the user in the social network data). However in some cases, one or more second users having a second-degree relationship to the first user (that is, they are connected to an intermediate user who is directly connected to the first user) may also be identified. Including users having a second-degree relationship may be particularly beneficial where the number of directly connected users is low,

At step 464, a matrix is generated (or retrieved, where such a matrix already exists) for each of the identified second users, each matrix mapping time slots to locations of the second users. Each time slot in the matrices for the second users preferably corresponds to a time slot of the matrix for the first user.

At step 466, one or more candidate second users are identified, Typically, this involves identifying those second users which have which have both the preceding and subsequent time slots relating to the same location as the first user, and have no (or at least fewer) gaps in the intermediate time slots.

Where multiple candidate second users are identified, they may be ordered based on strength of the relationship between the first user and the particular candidate second user. For example, a candidate second user who calls the first user daily may be treated as having a stronger relationship than a candidate second user who has emailed the first user once.

The ordering may additionally or alternatively be based on the similarity between the matrix of the first user and the matrix of the candidate second user. In a very basic example, where two users have identical matrices but for the empty time slots in the first user's matrix, there could be seen to be a strong basis for inferring the locations for the empty time slots based on the second user's matrix.

Finally, at step 468, the empty time slots in the matrix for the first user are filled. This may be based on the first candidate second user in the ordered set. In some cases, it may alternatively be based on a plurality of candidate second users by aggregating the matrices of the plurality. For example, aggregation may involve calculating the most common location across the plurality for each of the missing time slots in the first user's matrix.

Regardless of which method is used to infer the location for empty time slots, the method then proceeds to attempt to match a first user device to one or more other user devices.

At step 407, a pre-filter can be applied, particularly where the number of user devices is large. The pre-filter serves to eliminate user devices which certainly do not relate to the first user device, thereby avoiding the need for a more computationally intensive comparison.

The pre-filter comprises first generating the most common location for each user device. If the most common location of a given user device differs significantly from the most common location of the first user device (for example, they are in different parts of a country), then it can be assumed that the devices relate to different users and no further computation is needed.

At step 408, the matrix for the first user device is correlated to matrices for the other user devices (which have not been eliminated by the pre-filter, in cases where it is used). Each correlation between the first user device and a second user device produces a probability value as an output. The probability value indicates the likelihood that the first user device and the second user device are associated with the same user.

In one implementation, the correlation may comprise counting the number of occasions where a time slot for the first user device matches a time slot for the second user device. The number of matches as a proportion of the total number of time slots can then be taken as the probability.

In some cases, some locations may be weighted so as to contribute more to the probability. For example, matching a home location between a first user device and a second user device may be as much more important than matching a work location.

In further cases, different patterns of locations can be weighted differently. For example, the series of locations between a home location and a work location in the morning (potentially corresponding to a morning commute) may be weighted more highly than a series of locations around a work location during a work day (which may be followed by multiple users who are colleagues).

Finally, at step 410, the probability for each pair of devices is compared to a threshold value. If the probability is above a threshold value (which may be 90%), the first user device and the second user device are recorded as being associated with the same user.

Thus this method can determine which devices belong to the same person based on their probability of being located together. In this manner, the number of people in a location can be calculated much more accurately. This leads to downstream benefits where subsystems, which are controlled based on the number of people, can operate more efficiently and effectively in a given location.

### Cohort Inference

As described above, the usage profiles of two or more devices can be analysed to infer a probability that the two devices belong to the same user. However, in some applications, where the devices do not belong to the same user (for example, if the probability falls below the threshold value), it may be possible to infer that users of the two or more devices belong to the same cohort. This may include family members or people who otherwise live in the same residence, co-workers, travel companions or people with common interests (such as fans of the same football club).

FIG. 7 shows a method for inferring that two or more users belong to a common cohort. Although not shown in the Figure, the method typically begins with steps 402 to 406 as described above. Thus, where it is desired to perform both multiple device inference (as described above in relation to FIG. 2) and cohort inference (as will be described below in relation to FIG. 7), it is possible for steps 402 to 406 to be performed once, and the results of steps 402 to 406 being used for both analyses.

Thus, at step 442, following steps 402 to 406, a pre-filter can be applied, particularly where the number of user devices is large. In this case, the pre-filter may be based on social network data for users associated with each user device. The social network data may be associated with a source of event records (for example, a mobile operator) or may be separate. In some cases, the social network data can come from multiple sources. The pre-filter can be configured to eliminate user devices corresponding to users who are a pre-determined number of degrees (such as more than two degrees) from the first user, and are thus unlikely to belong to the same cohort.

For example, if a given user is not directly connected to the first user (that is, does not have a first degree relationship with the first user) and is not connected to any other user connected to the first user (that is, does not have a second degree relationship with the first user), it could be inferred that it is unlikely the user belongs to the same cohort as the first user. In such a case, further analysis may be deemed unnecessary, thereby avoiding the need for a more computationally intensive comparison. It should be noted that a pre-filter based on social network data may be inappropriate when considering ad-hoc or loosely related cohorts (such as users who share a travel route or users who share a common interest).

At step 444, a mask is generated based on the type of cohort. Typically the mask will comprise a binary value for each time slot in a given period (for example, over a week). In this manner, only locations corresponding to certain time slots (that is, those having a “1” in the mask) will be considered in inferring membership to a cohort of a certain type. The mask is then applied to each of the matrices to generate a set of masked matrices. Each masked matrix may include a number of time slots with no value due to the masking.

Some masks are static, and can be used across a wide range of users. For example, a mask intended to identify co-workers may be used across multiple different groups, as a large proportion of people work similar hours on weekdays. However, in some cases, the masks can be dynamically generated based on external information. For example, where it is intended to infer supporters of a given football team, the mask may be generated based on match scheduling information for that team so as to include only locations within an hour of a match only on match days.

At step 446, the masked matrix for the first user device is correlated to matrices for the other user devices. Each correlation between the first user device and a second user device produces a probability value as an output. The probability value indicates the likelihood that the user associated with the first user device and the user associated with the second user device belong to a common cohort. The particular cohort is typically indicated by the mask used at step 442.

Finally, as step 448, the probability for each pair of devices is compared to a threshold value. If the probability is above a threshold value (such as about 80%), the first user device and a second user device are recorded as belonging to a common cohort.

Examples of this in use can be seen in FIGS. 8A to 8D.

FIG. 8A shows example matrices 452, 454, 456 for three different devices. Each pictured matrix includes 24 time slots, each corresponding to an hour in a given day. Each time slot holds a value corresponding to a location.

FIG. 8B shows the application of a first mask 458A to the matrices 452, 454 and 456. In this case, the first mask 458A is configured to identify users who are co-workers. Accordingly, the first mask 458A only allows time slots during typical work hours (09:00 to 17:00) to be considered. When the first mask 458A is applied to the matrices 452, 454, 456, a set of masked matrices 452A, 454A, 456A is generated. Based on this, it may be calculated that a first user corresponding to matrix 452A is highly likely to be a co-worker with a third user corresponding to matrix 456A, and is highly unlikely to be a co-worker with a second user corresponding to matrix 454A.

FIG. 8C shows the application of a second mask 458B to the matrices 452, 454 and 456. In this case, the second mask 458B is configured to identify users who live together (that is, they are family, housemates or the like). Accordingly, the second mask 458B only allows time slots during typical hours that a user will be at their home (18:00 to 08:00) to be considered. When the second mask 458B is applied to the matrices 452, 454, 456, a set of masked matrices 452B, 454B, 456B is generated. Based on this, it may be calculated that a first user corresponding to matrix 452B is highly likely to live with a second user corresponding to matrix 454B, and is highly unlikely to live with a third user corresponding to matrix 456B.

FIG. 8D shows the application of a third mask 458C to the matrices 452, 454 and 456. In this case, the third mask 458C is configured to identify users who share a common travel route. Accordingly, the third mask 458C only allows time slots during typical hours that a user will be commuting (08:00 to 09:00 and 17:00 to 18:00) to be considered. When the third mask 458C is applied to the matrices 452, 454, 456, a set of masked matrices 452C, 454C, 456C is generated. Based on this, it may be calculated that all three users corresponding to the matrices 452C, 454C and 456C are highly likely to share a common travel route.

Thus this method can infer that two or more users belong to the same cohort. This leads to downstream benefits where subsystems, which are controlled based on the people in a given area, can operate more efficiently and effectively.

### Infrastructure

The methods above provide for various footfall analytics to be performed. In use, these methods are typically performed in a system. One such exemplary system is shown in FIG. 9.

In this system, the data ultimately originates from a mobile network operator 10. The data is stored in one or more data stores 11. Each of the data stores may be dedicated to a different kind of data, for example one may store event data, another may store customer data etc. For example, each data store 11 may relate to one or more of real-time network data, network and OSS data, application data or operational data.

The mobile network operator 10 provides an API service 12. In response to receiving an API call, the API service 12 retrieves the appropriate data from the data stores 11, and returns the data. Access to the API service 12 may be limited to only certain parties, and therefore may require authentication. Requests made to the API service 12 may be made as federated queries, such that, in response to the query, multiple data sources are searched and the results compiled. In some cases, the API service 12 may send data to a predetermined recipient other than in response to receiving an API call. For example, this may occur when newly stored data in the data stores 11 matches a predetermined condition. In this manner, the API service 12 may make use of “push” transmission.

The analytics platform 20 is provided to administer the methods noted above.

The analytics platform comprises a client API 21 which is configured to call the appropriate API service 12 at the mobile network operator 10. These calls are performed in order to retrieve the data (such as event records) needed for the analytic methods to be performed. The data can be retrieved in real-time (or at least in near-real-time, where data is available within around 15 minutes of the corresponding event occurring).

Communication between the API service 12 and the client API 21 typically involves a RESTful architecture. Thus, requests for resources may be made by the client API 21 using standard HTTP methods, and responses received using HTML, XML or JSON over FTP or HTTP.

Data received at the client API 21 is then transmitted to a data processing module 22. The received data may fall into one of three categories: structured data (which follows the mandatory core of a pre-agreed standard), semi-structured data (which follows the optional additions to the pre-agreed standard) or unstructured data (which does not follow a pre-agreed standard).

In some cases, a plurality of mobile network operators 10 may provide API services 12 for their respective data. In this case, the client API 21 may retrieve data from each of the mobile network operators 10 in turn, and pass the retrieved data from each mobile network operator 10 in turn to the data processing module 22.

The data processing module 22 is configured to process the incoming data according to its type. More precisely, the data processing module 22 contains one or more operational service components which operate to process the data into a form suitable for storage and/or future use. The components may comprise one or more structured loaders which accept structured data. The components may additionally or alternatively comprise one or more semi-structured loaders which are configured to operate on semi-structured data. The semi-structured loaders may operate to determine the data fields of the semi-structured data and to create appropriate storage objects. The components (which may include the structured loaders or the semi-structured loaders) may operate to perform one or more of data validation, data anonymisation, data enrichment and transformation, data optimisation (such as indexing), data auditing and logging or the like. Once processed, the data is then stored in a data store 23.

The data store 23 typically holds four kinds of data: mobile subscriber data, reference data, system metadata and derived data. Mobile subscriber data contains all the “raw” data originating from the network events and pertaining to a mobile subscriber. This typically includes the event records, and can be regarded as the primary kind of data for analytics. Reference data comprises secondary data which can improve the operation of the analytics. This can include network site/cell configuration data, geographical data (such as GIS polygon data), external footfall verification statistics, population statistics or weather data. Reference data may be updated less frequently than mobile subscriber data, or may be treated as static and not updated. System metadata typically holds data related to the operation of various APIs, such as call definitions and schedule, in order to maintain flexibility within the system. Derived data comprises the calculated and inferred data based on the mobile subscriber data and the reference data.

An analytics processing module 24 is provided, which acts on the data stored in the data store 23. As will be appreciated, the analytics processing module 24 typically implements the footfall analytics methods described herein, then stores the results in the data store 23. More precisely, the analytics processing module 24 may comprise a processor and memory comprising instructions which, when executed by the processor, cause the processor to perform one or more of the methods described above.

The analytics platform 20 further comprises an API service 25 which is configured to receive requests from one or more external entities. The API service 25 may provide for one or more different classes of services. A first class comprises data extraction, whereby there is provided a mechanism for delivering raw data sets. In most cases, this is likely to be derived data. However, in some situations (such as where the primary data source is unavailable), other types of data may also be provided. A second class comprises data visualisation, whereby there is provided a mechanism for delivering data expressed in a visual manner (for example, as charts, graphs) or processed for use in visualisation (such as the provision of KML/KMZ files for geographic annotation and visualisation). A third class comprises insights, whereby there is a mechanism provided for delivering reports (preferably in a pre-defined format). This may function to provide a formatted output of raw data (which may in turn comprise visualisations).

An analytics portal 32 can be provided to allow for a user interface for the analytics platform. In particular, the analytics portal 32 is configured to allow for visualisation and reporting of the data. It typically comprises a webserver which is configured to retrieve data from the analytics platform by means of the API service 25 and to provide one or more dynamic webpages. Each webpage is generated when called to show views of the footfall data. This may be done using standard portlets.

One or more subsystem controllers 34 may also be in communication with the analytics platform by means of the API service 25. The corresponding subsystem (such as an air conditioning subsystem) can be configured to operate according to the retrieved data.

Although shown separately, it is envisioned that the analytics platform and the analytics portal may be operated together, and may be provided as a single system or computer program product, such that the analytics portal simply provides a user interface over the API service 25.

Thus, in a preferred embodiment, a system for performing analytics in a network is provided. The system preferably comprises an analytics platform 20. The analytics platform 20 preferably comprises a client API module 21 configured to call an API service 12 at a mobile network operator 10 and, in response to the call, receive data from the API service 12; a data store 23; a data processing module 22 configured to process the received data and store the processed data in the data store 23; an analytics processing module 24 configured to perform one or more analytics methods (such as those described above in relation to FIGS. 2 to 8D); and an API service module 25 configured to configured to receive requests from one or more external entities, and in response to the requests, provide one or more data services.

Example analytics portal 32 will now be described in relation to FIGS. 10A and 10B. In these examples, the analytics portal 32 comprises a webserver 40. The webserver 40 is typically configured to receive requests and responses in common webserver formats (such as HTTP). Responses can include the provision of a dynamic portal or portal pages. The webserver 40 is preferably be configured to adhere to appropriate standards, such as JSR 168. In use, the webserver 40 (or at least components of the webserver 40) may be in communication with various other modules. Thus in the example shown in FIG. 10A, the webserver 40 is in communication with API service 25 in the analytics platform 20. In this manner, content required for operation of the webserver 40 may be supplied via appropriate calls to the API service 25. The webserver 40 is also in communication with a data store 54 via an API service 52 (and preferably via data extraction functions provided by API service 52). In such an example, data store 54 is typically configured to store portal metadata for the webserver 40. The data store 54 and the API service 52 can be separate from the analytics platform 20.

In some embodiments, the API service 52 and the data store 54 are integrated with the API service 25 and the data store 23. An example of this is shown in FIG. 10B, where the webserver 40 is in communication with data store 23 via API service 25 (and preferably via data extraction functions provided by API service 25, as described above). The data store 23 can therefore be configured to store portal metadata, and the API service 25 configured to supply the portal metadata on appropriate calls being made.

As can be seen in both FIGS. 10A and 10B, the webserver 40 comprises a portal access module 42 configured to assess the credentials of a user or a group, and based on this assessment, evaluate whether components (such as portlets) are visible to a given user or group. To this end, the portal access module 42 may be in communication with a data store 23, 54 holding portal metadata, preferably via a suitable API service 25, 52. Based on the results of one or more queries to the API service, the portal access module 42 can then evaluate visibility or access.

The webserver 40 further comprises a layout control module 44. The layout control module 44 is configured to query the API service 25, 52 to retrieve portal metadata, and based on the retrieved portal metadata, determine where and how to display pages and portlets. To this end, the layout control module 44 can be in communication with a portlet library 46 having one or more portlets 48, The portlet library 46 is configured to make available modular components which can be used to display different aspects of data, and preferably adheres to appropriate standards, such as JSR 168. The portlets 48 may include map portlets, chart portlets, image portlets, text portlets, or any other suitable type of portlet.

The portlet library 46 may also be configured to retrieve content from a suitable data store for use in the display of one or more of the portlets 48. In particular, the portlet library 46 may make a call to an API service 25, 52 to retrieve data for use as content. In use, each portlet 48 can be initialised and maintained by the layout control module 44 based on the retrieved portal metadata. In this manner, the layout control module 44 prepares the portal and portal pages for use in responses from the webserver 40.

Thus, in preferred embodiments, a system for operating an analytics portal is provided. The system comprises a portal access control module 42 configured to evaluate the credentials of a user or group, a portlet library 46 configured to store one or more portlets 48, and a layout control module 44 configured to initialise one or more portal pages based on portal metadata and the one or more portlets.

This application describes various embodiments of the present invention by way of one or more examples. However, as will be apparent to the skilled person, various modifications and changes can be made to the embodiments and examples described without departing from the spirit and scope of the present invention. Such modifications and changes are included within the scope of this application.

This application describes various technically implementable analytics systems and methods. Commercial implementation of any of the embodiments described in this application may be subject to applicable privacy laws.

1. A method for detecting a common user of a plurality of user devices in a network, comprising:
receiving a plurality of event records, each event record corresponding to an event in a network and comprising a device identifier and event information;
calculating a correlation between a first subset of the plurality of event records having a first device identifier and a second subset of the plurality of event records having a second device identifier different from the first device identifier; and
based on the correlation, calculating whether the first and second device identifiers relate to user devices associated with the same user.

2. The method of claim 1, wherein calculating a correlation comprises:
generating a first matrix based on the event dates, the event times and the event locations of each of the event records in the first subset;
generating a second matrix mapping event dates, event times and event locations of each of the event records in the second subset;
comparing the first matrix and the second matrix; and
based on the comparison, calculating a probability that the first and second device identifiers relate to user devices associated with the same user.

3. The method of claim 2, wherein calculating whether the device identifiers relate to user devices associated with the same user comprises:
if the probability is above a threshold value, recording that the device identifiers relate to user devices associated with the same user.

4. The method of claim 2, wherein calculating the probability comprises calculating the number of entries in the first matrix which match entries in the second matrix as a proportion of the total number of entries in the first matrix.

5. The method of claim 2, further comprising:
calculating one or more weights for one or more locations; and
calculating the probability based on the weights.

6. The method of claim 5, wherein one or more weights are based on the time of day.

7. The method of claim 2, further comprising:
calculating one or more weights for one or more ordered sets of locations; and
calculating the probability based on the weights.

8. The method of claim 1, further comprising, prior to calculating a correlation:
calculating a most common location for the first device;
calculating a most common location for the second device;
comparing the most common location for the first device with the most common location for the second device; and
based on the comparison, determining whether the first and second devices could be associated with the same user.

9. A method for detecting a common cohort for a plurality of users of user devices in a network, comprising:
receiving a plurality of event records, each event record corresponding to an event in a network and comprising a device identifier and event information;
calculating a correlation between a first subset of the plurality of event records having a first device identifier and a second subset of the plurality of event records having a second device identifier different from the first device identifier; and
based on the correlation, calculating whether the first and second device identifiers relate to user devices associated with users belonging to a common cohort.

10. The method of claim 9, wherein calculating a correlation comprises:
generating a first matrix based on the event dates, the event times and the event locations of each of the event records in the first subset;
generating a second matrix mapping event dates, event times and event locations of each of the event records in the second subset;
comparing the first matrix and the second matrix; and
based on the comparison, calculating a probability that the first and second device identifiers relate to user devices associated with users belonging to a common cohort.

11. The method of claim 10, wherein comparing the first matrix and the second matrix comprises:
selecting a mask based on a type of cohort;
applying the mask to the first matrix to generate a first masked matrix;
applying the mask to the second matrix to generate a second masked matrix; and
comparing the first masked matrix and the second masked matrix.

12. The method of claim 10, wherein generating a matrix comprises:
dividing a time period into a plurality of time slots;
determining a location for each time slot; and
recording the location in the matrix.

13. The method of claim 12, wherein determining a location for each time slot comprises:
retrieving the start time of the time slot;
selecting an event record in the subset of event records having time data closest to the start time;
recording the location of the event record as the location for the time slot.

14. The method of claim 12, wherein determining a location for each time slot comprises:
retrieving the start time of the time slot;
selecting an event record in the subset of event records having time data closest to the start time;
temporarily recording the location of the event record as the location for the time slot;
aggregating the plurality of time slots into a plurality of time slot groups;
calculating the most common location across each time slot group; and
recording the most common location for each time slot group as the location for each of the time slots in time slot group.

15. The method of claim 12, wherein determining a location for each time slot comprises:
dividing each time slot into a plurality of sub-slots, the plurality of sub-slots comprising two edge sub-slots and one or more central sub-slots;
for each edge sub-slot:
retrieving the start time of the edge sub-slot;
selecting an event record in the subset of event records having time data closest to the start time; and
recording the location of the event record as the locations for the edge sub-slot;
for each central sub-slot:
retrieving the start time of the time slot;
selecting an event record in the subset of event records having time data closest to the start time; and
temporarily recording the location of the event record as the location for the time slot;
calculating the most common location across the central sub-slots; and
recording the most common location for each central sub-slot.

16. The method of claim 12, wherein the matrix is associated with a first user, and wherein determining a location for each time slot comprises:
identifying one or more second users associated with first user;
retrieving a matrix for each second user; and
recording the location for a time slot in the matrix of one or more of the second users as the location for a corresponding time slot in the matrix associated with the first user.

17. A computer-readable medium having computer-executable instructions stored thereon which, when executed by a computer, cause the computer to perform the method of claim 1.
